(19) United States
(12) Patent Application Publication
(10) Pub. No.: US 2019/0362140 A1
(43) Pub. Date: Nov. 28, 2019

(54) SENSOR, STATISTICAL ANALYSIS SYSTEM AND METHOD FOR DETERMINING AND DISPLAYING THE HEIGHT OF A JUMP PERFORMED BY A SPORTS PRACTITIONER

(71) Applicant: PIQ, NEUILLY SUR SEINE (FR)

(72) Inventors: lvan SELIVANAU, BREST (BY); Fernando ROMAO, PARIS (FR); Andrei SHELEH, MINSK (BY)

(21) Appl. No.: 16/314,089

(22) PCT Filed: Jun. 28, 2017
(86) PCT No.: PCT/FR2017/051724

§ 371 Date: Aug. 5, 2019

(30) Foreign Application Priority Data
Jun. 29, 2016 (FR) 1656129

(51) Int. Cl. G06K 9/00; A63B 24/00

(52) U.S. Cl. CPC G06K 9/00342; A63B 2024/0056; A63B 24/0062; A63B 24/0021

(57) ABSTRACT

In the field of multi-sport data sensors for evaluating the performance of a sports practitioner in various sporting disciplines, in particular in board sports, there is disclosed a method, a sensor and a statistical analysis system for analyzing the path of a surf practitioner performing a jump, and more particularly for calculating the height of the jump. The method can advantageously be applied to kitesurfing, but is not limited thereto. It is based on filtering and integrating the data from an accelerometer. In certain embodiments, it advantageously includes a quadratic correction step for correcting errors introduced by uncertainties relating to the accelerometer measurements.

The present invention relates to the field of multi-sport data sensors intended for evaluating the performance of a sports practitioner in various sporting disciplines, in particular in board sports.

In the field of sport, connected sensors are known for measuring a set of raw parameters generated by practising the sport. The connected sensor comprises a set of measurement sensors such as accelerometers and/or gyrometers, magnetometers or also all types of measurement sensors. These data are then analyzed in order to deduce therefrom statistics on the performance of the sports practitioner. Depending on the sport, the parameters are used to detect sequences characteristic of the sport and measure specific parameters of these sequences. For example, with respect to tennis, the services can be detected and the velocity of the service measured. With respect to golf, the swing is detected, its width and the force of impact with the ball can be measured.

Within the context of board sports, among other things interest is centred on the jumps performed by the sports practitioner. Depending on the sport, the jump can be calculated according to the rules of ballistics, with the sports practitioner being compared to a projectile during the jump. In contrast, in other sports, the path of the sports practitioner cannot be compared to that of a projectile; this is the case in particular when the aerodynamic aspects are significant or when the sports practitioner is subjected to a propulsion force during the jump. This latter case typically obtains for a surf practitioner propelled by a kite (kitesurfing).

The purpose of the present invention is to overcome the aforementioned drawbacks by proposing a method intended to analyze the path of a kitesurfing practitioner during a jump and more particularly to calculate the height of the jump. This method can advantageously be applied to the practice of kitesurfing propelled by a kite, without being limited thereto. It is based on the filtering and integration of the data from an accelerometer. In certain embodiments it advantageously comprises a quadratic correction intended to correct the errors introduced by uncertainties relating to the accelerometer measurements.

The invention relates to a method for determining and displaying the height of a jump performed by a sports practitioner practising a water-based board sport, said method being carried out by a statistical calculation system comprising a connected sensor, said connected sensor comprising at least one measurement sensor including an accelerometer, characterized in that it comprises:
A step of determining the ascending velocity of the sports practitioner based on data originating from the accelerometer;
A step of detecting a jump by recognizing the different phases of the jump by analyzing the acceleration and the velocity of the sports practitioner;
A step of determining the height values reached by the sports practitioner during the jump, by integration of the ascending velocity between the start and the end of the jump;
A step of determining the height of the jump as being the maximum value from the height values;
A step of displaying the height of the jump by a display module of the statistical calculation system.

According to a particular embodiment, the step of determining the ascending velocity comprises determining the ascending acceleration according to the following steps:
A step of determining the acceleration of the sports practitioner in a frame linked to the sensor based on data originating from the accelerometer;
A step of determining the attitude of the sensor in a fixed frame linked to Earth;
A step of determining the ascending acceleration by projecting the acceleration on the vertical axis of the fixed frame.

According to a particular embodiment, the step of determining the ascending velocity also comprises:
A step of applying a high-pass filter to the ascending acceleration;
A step of determining the ascending velocity by integration of the filtered ascending acceleration;
A step of applying a high-pass filter to the ascending velocity thus determined.

According to a particular embodiment, the step of detecting a jump comprises in order:
Detecting the start of the jump when the ascending velocity exceeds a predetermined threshold;
Detecting the start of the descent when the ascending velocity becomes negative;
Detecting the start of the water landing when the ascending acceleration exceeds a predetermined threshold;
Detecting the end of the water landing, and thus the end of the jump, when the ascending acceleration becomes less than a predetermined threshold.

According to a particular embodiment, detection of the water landing does not take place unless the ascending acceleration exceeds said predetermined threshold for at least a predetermined time.

According to a particular embodiment, the method also comprises:
A step of correcting the height values reached by the sports practitioner during the jump, in order to cancel the height determined at the end of the jump.

According to a particular embodiment, the correction step consists of applying a quadratic correction to the height values reached by the sports practitioner.

According to a particular embodiment, the correction step consists of applying a linear correction to the height values reached by the sports practitioner.

According to a particular embodiment, the correction step consists of applying a linear combination of a quadratic correction and a linear correction to the height values reached by the sports practitioner, the coefficients of the linear combination being determined by a statistical analysis of several jumps.

According to a particular embodiment, the correction step is applied on a subsampling of the set of height values reached by the sports practitioner during the jump.

According to a particular embodiment, the connected sensor also comprises a satellite positioning module, the method comprising:
A step of determining a second height of the jump based on the satellite positioning; and
A step of combining the determined height of the jump and the second height of the jump as a function of the confidence level of each of these values in order to determine the final estimation of the height of the jump.

The invention also relates to a statistical calculation system for determining and displaying the height of a jump performed by a sports practitioner practising a water-based board sport, characterized in that it comprises:
a connected sensor, said connected sensor comprising at least one measurement sensor including an accelerometer;
means of determining the ascending velocity of the sports practitioner from data originating from the accelerometer;
means of detecting a jump by recognizing the different phases of the jump by analyzing the acceleration and the velocity of the sports practitioner;
means of determining the height values reached by the sports practitioner during the jump, by integration of the ascending velocity between the start and the end of the jump;
means of determining the height of the jump as being the maximum value from the height values;
means of displaying the height of the jump.

The invention also relates to a connected sensor for determining the height of a jump performed by a sports practitioner practising a water-based board sport, characterized in that it comprises:
at least one measurement sensor including an accelerometer;
means of determining the ascending velocity of the sports practitioner based on data originating from the accelerometer;
means of detecting a jump by recognizing the different phases of the jump by analyzing the acceleration and the velocity of the sports practitioner;
means of determining the height values reached by the sports practitioner during the jump, by integration of the ascending velocity between the start and the end of the jump;
means of determining the height of the jump as being the maximum value from the height values;
means of transmitting the height of the jump.

The invention also relates to a computer program comprising instructions capable of implementing each of the steps of the method according to the invention when said program is executed on a computer.

The invention also relates to a data storage means, removable or not, partially or totally readable by a computer or a microprocessor containing computer program code instructions for executing each of the steps of the method according to the invention.

Other features and advantages of the invention will become more apparent from the following description.

In the attached drawings, given by way of non-limitative example:

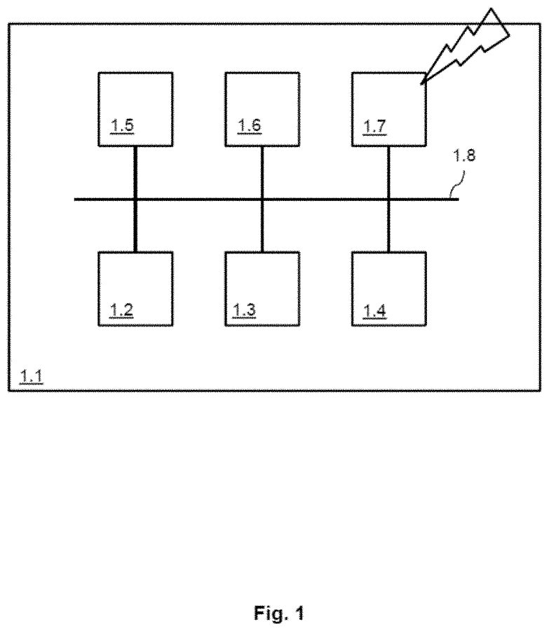

FIG. 1 shows the architecture of a connected sensor according to an embodiment of the invention;

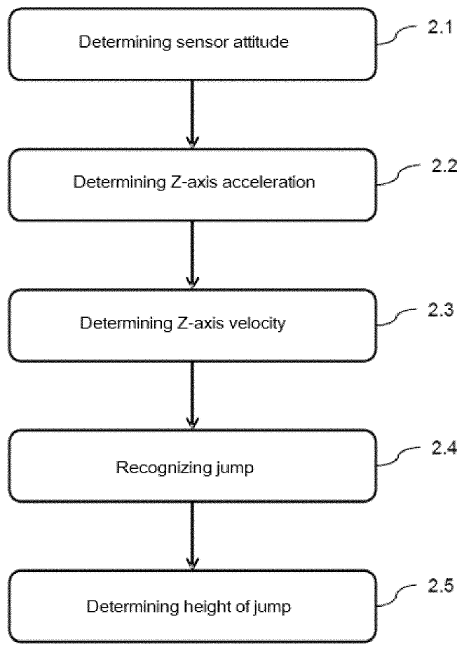

FIG. 2 shows the general flow chart of the method of calculating the height of the jump according to an embodiment of the invention;

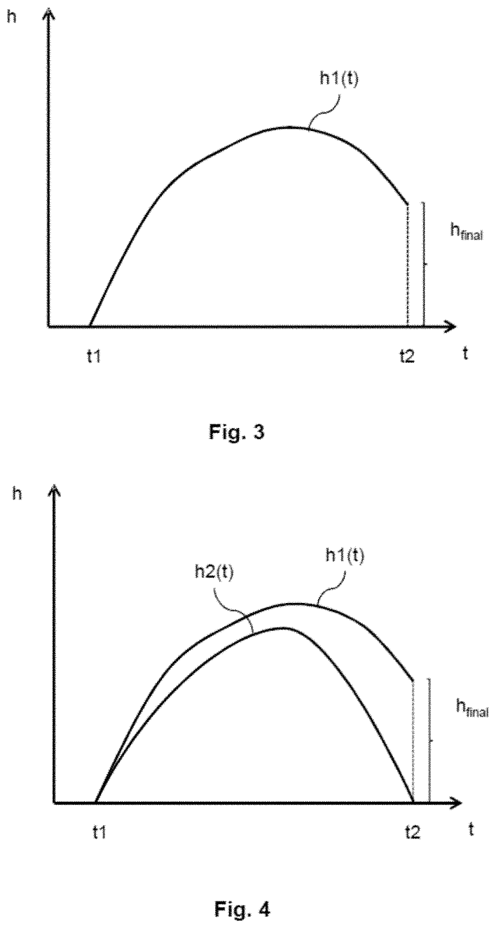

FIG. 3 shows the curve of the heights of a jump according to an embodiment of the invention;

FIG. 4 shows the corrected curve of the heights of a jump according to an embodiment of the invention;

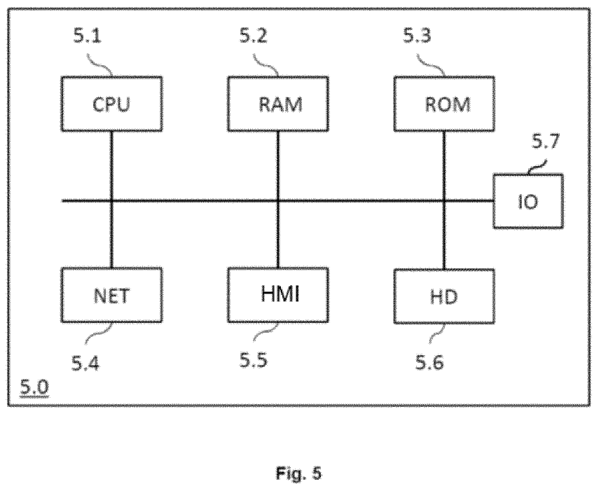

FIG. 5 is a block diagram of a data processing device for implementing one or more embodiments of the invention.

The invention relates to a method using a connected sensor, comprising a set of measurement sensors, borne by a water-based board sports practitioner, both for identifying the phases of a jump and for measuring the height thereof. The connected sensor comprises at least one accelerometer making it possible to obtain acceleration measurements from the connected sensor in a three-dimensional frame linked to the connected sensor. Firstly, the frame linked to the sensor is oriented within a world frame linked to Earth. To this end, the gravitational constant acceleration is detected, serving to identify the attitude of the sensor and in particular the vertical axis called Z-axis of the world frame (X, Y, Z). Secondly, the measured acceleration component from the sensor along this vertical axis or Z-axis is determined over time. Filtering and integration steps make it possible to calculate the ascending velocity or vertical velocity along this same Z-axis. The different stages of a jump are then detected by analyzing the ascending acceleration and ascending velocity curves. These phases are the take-off, ascent phase, descent phase and landing or in this case, water landing. Typically, the take-off will be detected when the ascending velocity becomes greater than a threshold. The start of the descent is detected when the ascending velocity becomes negative, the water landing when the ascending acceleration increases abruptly, and the end of the water landing when the ascending velocity drops below a threshold.

Once the jump has been detected, i.e. when the succession of events constituting the jump has been detected, in the expected order, measurement of the vertical position or height of the connected sensor is undertaken. This measurement is obtained by integration of the ascending velocity, with a zero height being attributed to the moment of take-off. The integration makes it possible to obtain a measurement of the height at any moment of the jump and therefore to determine the maximum height reached, which is the sought height of the jump.

Experimentation shows that the final measured height, i.e. the height at the time of the water landing, is not always zero, which is the expected result; indeed, the sports practitioner starts the jump from the water level and falls back to the same level. This difference is due to various uncertainties such as those relating to the initial acceleration measurements (noise, bias), or to inaccuracies in the calculation of attitude, i.e. of the orientation of the sensor in space. In certain embodiments, a quadratic correction is carried out on the height measurements in order to ensure that the final measured height is zero. The intermediate height values measured are corrected and therefore also the maximum value constituting the measured height of the jump. The quadratic correction of the measurement of the jump heights requires storing all of the heights during the jump. In certain embodiments of the invention, the measurements of the jump heights are sub-sampled with respect to the acceleration data obtained from the sensors in order to reduce the quantity of data that must be stored and thus the memory size needed.

FIG. 1 shows the architecture of a connected sensor 1.1 according to an embodiment of the invention. The connected sensor 1.1 comprises a set of measurement sensors 1.2, 1.3 and 1.4. For example, the measurement sensor 1.2 is an accelerometer that makes it possible to measure linear acceleration values along the three axes of a frame linked to the sensor. The measurement sensor 1.3 is, for example, a gyrometer making it possible to measure the angular rotation velocities about the three axes of the frame linked to the sensor. The measurement sensor 1.4 is, for example, a magnetometer allowing measurement of the magnetic field in which the sensor is immersed. Other types of measurement sensors can be present, such as a satellite positioning component of the GPS type, a heart rate monitor, an impact detector, or any other type of measurement sensor.

The measurement sensors produce measurement values on a frequency typically around 250 Hz that are stored in a storage module 1.5 that can be a writable memory component, a memory card, a disk or any other component allowing digital data to be stored. The connected sensor is controlled by a processor 1.6 that allows the measurement sensors to be controlled as well as the data originating from the measurement sensors to be read, and optionally analyzed. In particular, the processor is able to execute algorithms for processing the raw data originating from the measurement sensors in order to produce processed data and statistical results on the processed data. For example, the raw data originating from the measurement sensors can be filtered, integrated and compared to thresholds.

The connected sensor is also typically provided with a communication module 1.7 that allows communication with various data processing devices that are external to the connected sensor. These communications can have several functions. For example, it is possible to transmit to the connected sensor operating parameters or updates of the algorithms executed by the processor 1.6. In the context of the invention, the communication module serves, among other things, to communicate the data to an external data processing device in order to display the statistical results of the sports practice. For example, the sports practitioner can display their statistics on a smartphone. The communication technology is advantageously a radio technology such a Bluetooth or WiFi, but any communication technology, wireless or wired, can be used. Depending on the embodiment of the invention, the processing carried out on the raw data originating from the measurement sensors in order to obtain processed data and statistical results on the sports practice can be carried out by the processor 1.6 within the sensor. In this case, only the processed data and the statistical results are transmitted outside for display. In other embodiments, the raw data originating from the sensors are transmitted and the processing is carried out on an external device such as a smartphone serving to display the results. In other embodiments, the processing can be distributed between the processor 1.6 of the connected sensor and the external device. In certain embodiments, the connected sensor is also equipped with a screen that then allows the direct display of the statistical results on the screen of the sensor. The different modules composing the connected sensor communicate between one another via the communication bus 1.8. This connected sensor is intended to be borne by the sports practitioner while practising the sport in order to allow statistics to be determined. For example, in the case of kite-surfing propelled by a kite, the sensor can be fixed either to the board used by the sports practitioner, or to another item of equipment of the sports practitioner such as the kite attachment harness.

FIG. 2 shows the general flow chart of the method of calculating the height of the jump according to an embodiment of the invention.

In the first step 2.1, the attitude of the connected sensor is determined. This requires situating a three-dimensional mobile frame linked to the sensor within a three-dimensional frame linked to Earth. For example, this step can be carried out according to the following method. The raw data originating from the accelerometer and from the gyroscope are obtained. These data are then corrected for any known constant error by a calibration step. The variation in the attitude of the mobile frame can then be determined based on the data from the gyroscope. Knowing this attitude, projecting the acceleration measured in the mobile frame into the fixed frame makes it possible to obtain the acceleration with respect to the fixed frame. This acceleration comprises a component linked to the Earth's gravity which can be removed. An acceleration generated by the movement of the sensor in the fixed frame is then obtained. A detailed description of this calculation can be found in the document S.O.H. Madgwick, R. Vaidyanathan, A. J. L. Harrison, “An Efficient Orientation Filter for IMU and MARG Sensor Arrays”, Department of Mechanical Engineering, University of Bristol, April 2010.

Once the attitude of the mobile frame linked to the sensor has been determined within a fixed frame linked to Earth, it is possible to project the three-dimensional acceleration measured by the accelerometer onto the vertical axis of the fixed frame in order to obtain the ascending acceleration, i.e. the vertical acceleration of the connected sensor. This is step 2.2 in FIG. 2. The component of the vertical acceleration due to the Earth's gravity has been removed from this ascending acceleration. The data originating from the accelerometer are typically affected by an unknown constant error as well as a measurement noise. The constant error is difficult to estimate, as the sensor is in movement. If the signal constituted by the ascending acceleration is considered over time, application of a high-pass filter to this signal makes it possible to preserve the development of the signal due to the movements of the sports practitioner while eliminating the constant error that is a low-frequency component. An example of a high-pass filter that can be applied to the measurement signal of the ascending acceleration is given by the formula:

Y₁=Yᵢ₋₁*α+(Xᵢ−Xᵢ₋₁)*α;

Where:
Xᵢ represents the unfiltered ascending acceleration at time i;
Yᵢ represents the filtered ascending acceleration at time i;
α represents a filtration coefficient.

An estimation of the ascending velocity of the connected sensor can be obtained by integration of the ascending acceleration. The integration can, for example, be calculated according to the following formula:

$${V}_{i} = {V}_{i - 1} + ( {T}_{i} - {T}_{i - 1} ) * \frac{( {A}_{i} + {A}_{i - 1} )}{2} ;$$

Where:
Aᵢ represents the ascending acceleration at time i;
Vᵢ represents the ascending velocity at time i;
Tᵢ represents the value of a time tag at time i; i.e. (Tᵢ−Tᵢ₋₁) represents the time elapsed between the time i−1 and the time i;

According to a particular embodiment, the ascending velocity will advantageously be calculated according to the following steps:
Determining the filtered ascending acceleration by applying a high-pass filter to the signal constituted by measurements of ascending acceleration;
Determining an ascending velocity by integration of the filtered ascending acceleration;
Determining the filtered ascending velocity by applying a high-pass filter to the signal constituted by the ascending velocity obtained by integration.

The ascending velocity thus obtained by filtering, integration and filtering of the result of the integration makes it possible to avoid the main errors linked with the acceleration data originating from the measurement sensors. This corresponds to step 2.3 in FIG. 2.

At the end of this step 2.3, a signal of ascending acceleration over time and a signal of ascending velocity over time are obtained. During step 2.4, these signals will be analyzed in order to detect a jump performed by the sports practitioner.

A jump corresponds to the succession over time of an ascent phase, a descent phase and a water landing. These phases are delimited by the succession of four events, the take-off, the start of the descent, the start of the water landing and the end of the water landing. Each of these events can be detected by analyzing at least one of the two signals constituted by the ascending acceleration and the descending acceleration. A jump will be recognized when the four expected events are detected in the expected order.

Before the jump, the ascending velocity is characterized by a substantially zero value affected by a noise due to the movements of the sports practitioners and to the measurement errors. The start of the jump is characterized by an ascending velocity that becomes clearly positive and remains so throughout the entire ascent phase. The start of the jump can therefore be detected by comparison of the ascending velocity to a threshold. When the ascending velocity becomes greater than the threshold, a potential start of a jump is detected.

Throughout the entire ascent phase, the ascending velocity is positive. The start of the descent is characterized by an ascending velocity that is cancelled out and then becomes negative. The start of the descent is therefore detected when the ascending velocity becomes negative.

During the ascent and descent phases, the movements of the sports practitioner are gentle. The ascending acceleration is thus characterized by small values during these phases. In contrast, the water landing represents an impact and is therefore characterized by an abrupt increase in the ascending acceleration values. The water landing is therefore detected by the ascending acceleration value exceeding a threshold. Advantageously, in order to avoid a false detection of the water landing that would be due to abrupt movements of the sports practitioner during the jump, the detection of the water landing will be limited to the ascending acceleration value exceeding a threshold during a given time. In practice, exceeding the threshold by a given number of consecutive ascending acceleration values will be tested, for example 11 consecutive values.

The end of the water landing is characterized by the return to surfing on the water and therefore an ascending acceleration that returns substantially to zero. The end of the water landing is therefore detected when the ascending acceleration becomes less than a threshold.

When the event corresponding to a jump of the sports practitioner is detected, it is possible to determine the moment t1 of the start of the jump and the moment t2 of the end of the jump. The integration of the ascending velocity then makes it possible to determine a height of the jump at each moment between the start of the jump at t1 and the end of the jump at t2.

FIG. 3 shows the calculation of the height of the jump h1(t) according to an embodiment of the invention. This curve illustrates the height calculated as a function of time between the moment t1 and the moment t2. The maximum value of this curve h1(t) between the moment t1 and the moment t2 gives us the height of the jump, which is the value sought. The initial integrated height value is determined as zero, since the sports practitioner starts the jump at water level. The height of the end of the jump, called h_{final}, obtained at time t2 is generally proved to be non-zero. Now, at the end of the jump, the sports practitioner falls back to the water level and therefore the height at the end of the jump should be the same as the height at the start of the jump; i.e. zero height. This difference can be justified, for example if the water landing takes place on a wave. However, this difference is generally an error caused by inaccuracy affecting the measurement of the acceleration by the accelerometers, the on-board gyrometers in the connected sensor, or also resulting from an inaccuracy in the detection of the start of the jump.

FIG. 4 illustrates the calculation of the height of the jump by applying a correction to the curve h1(t) in order to calculate a corrected curve h2(t). The correction is based on the observation that the final height of the jump is zero. In certain embodiments, the correction is only applied when the final height exceeds a given threshold.

According to a first embodiment of the invention, the correction applied to the curve h1(t) in order to obtain the corrected curve h2(t) is a quadratic correction. The curve h1(t) is constituted by a series of values typically obtained at the sampling frequency of the accelerometers present in the connected sensor. This frequency is typically of 100 Hz or 250 Hz. The application of the correction requires storing the curve h1(t), i.e. the set of calculated height values constituting this curve. Alternatively, with the aim of saving storage space, i.e. the size of the buffer that serves to store this data, it is possible to store only a sub-sampled version of this curve. For example, a version at 10 Hz constituted by storing one value in 10 or in 25 makes it possible to reduce by a factor of 10 or 25 the size of the buffer required for storage. It is noted here that an upstream sub-sampling of the acceleration or of the velocity would lead to significant calculation errors.

The measured ascending acceleration γₘ(t) can be expressed as follows:

γₘ(t)=γ₀+γ(t);

Where γ₀ corresponds to a unknown constant error and γ(t) to the real ascending acceleration, the measurement noise being disregarded here.

The calculation of h1(t) from the moment t1 comprises the calculation of the ascending velocity v(t) by integration of the acceleration:

v(t)=γ₀(t−t1)+∫ₜ₁^{t}γ(u)du;

Where t represents the running time for the calculation of the velocity value.

Calculation of the height is then obtained by a new integration:

$$h 1 ( t ) = \frac{{{γ}_{0} ( t - t 1 )}^{2}}{2} + \int {\int }_{t 1}^{t} γ ( u ) du ;$$

It is noted that the term ∫∫ₜ₁^{t}γ(u)du represents h2(t).

It is assumed that the height at the end of the jump is zero, therefore h2(t2)=0. From which it is deduced that:

$${γ}_{0} = \frac{2 h 1 ( t 2 )}{{( t 2 - t 1 )}^{2}} ;$$

The corrected curve of a quadratic correction h2(t) is thus obtained by the formula:

$$h 2 ( t ) = h 1 ( t ) - \frac{{{γ}_{0} ( t - t 1 )}^{2}}{2} ;$$

or also by replacing γ₀ by its value:

$$h 2 ( t ) = h 1 ( t ) - \frac{{{h}_{final} ( t - t 1 )}^{2}}{{( t 2 - t 1 )}^{2}} ;$$

with h_{final}=h1(t2).

This calculation being valid whether the curve h2(t) is sub-sampled or not, and regardless of the sub-sampling value.

The estimated height of the jump thus corresponds to the maximum value of the corrected curve of a quadratic correction h2(t) thus obtained.

According to an alternative embodiment of the invention, the correction applied to the curve h1(t) in order to obtain the corrected curve h2(t) is a linear correction. This linear correction is obtained by the formula:

$$h 2 ( t ) = h 1 ( t ) - \frac{{h}_{final} ( t - t 1 )}{( t 2 - t 1 )} ;$$

This embodiment gives good results in the context where the start of the integration is not well known, i.e. when the determination of t1 is affected by error.

According to yet another embodiment, the correction applied to the curve h1(t) in order to obtain the corrected curve h2(t) is a linear combination of the quadratic correction and the linear correction. In this case the coefficients ∝ and β of the linear combination can be determined by statistical analysis of several jumps in order to determine the coefficients giving a best estimation of the height values and thus of the maximum value, which is the height of the jump.

The curve h2(t) is then obtained by the formula:

h2(t)=∝h2l(t)+βh2q(t);

with h2l(t) corresponding to the corrected curve of a linear correction, h2q(t) corresponding to the corrected curve of a quadratic correction and α+β=1.

In a particular embodiment of the invention, the connected sensor is also provided with a satellite positioning module. In this case, the height values can be obtained directly by the satellite positioning module. However, the reliability and accuracy of the measurements originating from such a positioning module are dependent on the good reception of satellite data and on the number of satellites from which the data is received. The calculation methods described above based on accelerometer data are then used, according to circumstances, for confirming, for example by combination depending on the confidence level of each of the estimations, the data originating from the satellite reception module or also substituting for the latter when the satellite reception is unsatisfactory.

FIG. 5 is a block diagram of a data processing device 5.0 for implementing one or more embodiments of the invention. This can be typically the architecture of the external device capable of implementing the described methods. The data processing device 5.0 can be a peripheral such as a microprocessor, a workstation or a mobile telecommunication terminal. The device 5.0 comprises a communication bus connected to:
a central processing unit 5.1, such as a microprocessor, denoted CPU;
a random access memory 5.2, denoted RAM, for storing the executable code of the implementation method of the invention, as well as memory registers capable of recording variables and parameters necessary for the implementation of the method according to the embodiments of the invention; the memory capacity of the device can be supplemented by an optional RAM memory connected to an extension port, for example;
a read-only memory 5.3, denoted ROM, for storing computer programs for the implementation of the embodiments of the invention;
a network interface 5.4 is normally connected to a communication network on which digital data to be processed are transmitted or received. The network interface 5.4 can be a single network interface, or composed of an assembly of different network interfaces (for example wired and wireless interfaces or different types of wired or wireless interfaces). Data packets are sent over the network interface for transmission or are read from the network interface for reception under the control of the software application executed in the processor 5.1;
a user interface 5.5 for receiving inputs from a user or for displaying data to a user;
a storage device 5.6 such as described in the invention and denoted HD;
an input/output module 5.7 for receiving/sending data from/to external peripherals such as hard drive, removable storage media or others.

The executable code can be stored in a read-only memory 5.3, on the storage device 5.6 or on a removable digital support such as for example a disk. According to a variant, the executable code of the programs can be received by means of a communication network, via the network interface 5.4, so as to be stored in one of the storage means of the communication device 5.0 such as the storage device 5.6, before being executed.

The central processing unit 5.1 is capable of controlling and directing the execution of the instructions or of the portions of software code of the program or of the programs according to one of the embodiments of the invention, instructions that are stored in one of the aforementioned storage means. After powering up, the CPU 5.1 is capable of executing instructions from the main RAM memory 5.2, relating to a software application. Such a software program, when it is executed by the processor 5.1, causes the steps of the methods described to be executed.

The connected sensor optionally associated with an external device such as a smartphone therefore constitutes a statistical calculation system capable of calculating statistical parameters linked to the sporting practice of a user bearing the sensor. In particular, the system thus described is able to produce estimations of the height of the jumps performed by the sports practitioner. To this end, the sensor or the external device are capable of carrying out the calculations described in order to provide the sports practitioner with reliable statistics on their sporting practice.

In this embodiment, the device is a programmable device that uses a software program in order to implement the invention. However, additionally, the present invention can be implemented in hardware (for example, in the form of an application-specific integrated circuit or ASIC).

Naturally, in order to satisfy specific requirements, a skilled person in the field of the invention may apply modifications to the above description.

Although the present invention has been described above with reference to specific embodiments, the present invention is not limited to the specific embodiments, and the modifications that are within the field of application of the present invention will be obvious to a person skilled in the art.

1. Method for determining and displaying the height of a jump performed by a sports practitioner practising a water-based board sport, said method being carried out by a statistical calculation system comprising a connected sensor, said connected sensor comprising at least one measurement sensor including an accelerometer, the method comprising:
a step of determining the ascending velocity of the sports practitioner based on data originating from the accelerometer;
a step of detecting a jump by recognizing the different phases of the jump by analyzing the acceleration and the velocity of the sports practitioner;
a step of determining the height values reached by the sports practitioner between the start and the end of the jump by integration of the ascending velocity;
a step of determining the height of the jump as being the maximum value from the height values;
a step of displaying the height of the jump by a display module of the statistical calculation system.

2. Method according to claim 1, wherein the step of determining the ascending velocity comprises determining the ascending acceleration according to the following steps:
a step of determining the acceleration of the sports practitioner in a frame linked to the sensor based on data originating from the accelerometer;
a step of determining the attitude of the sensor in a fixed frame linked to Earth;
a step of determining the ascending acceleration by projecting the acceleration onto the vertical axis of the fixed frame.

3. Method according to claim 2, wherein the step of determining the ascending velocity also comprises:
a step of applying a high-pass filter to the ascending acceleration;
a step of determining the ascending velocity by integration of the filtered ascending acceleration;
a step of applying a high-pass filter to the ascending velocity thus determined.

4. Method according to claim 1, wherein the step of detecting a jump comprises in order:
detecting the start of the jump when the ascending velocity exceeds a predetermined threshold;
detecting the start of the descent when the ascending velocity becomes negative;
detecting the start of the water landing when the ascending acceleration exceeds a predetermined threshold;
detecting the end of the water landing, and thus the end of the jump, when the ascending acceleration becomes less than a predetermined threshold.

5. Method according to claim 4, wherein the detection of the water landing does not take place unless the ascending acceleration exceeds said predetermined threshold for at least a predetermined time.

6. Method according to claim 1, further comprising:
a step of correcting the height values reached by the sports practitioner during the jump in order to ensure that the final measured height is zero.

7. Method according to claim 6, wherein the correction step consists of applying a quadratic correction to the height values reached by the sports practitioner.

8. Method according to claim 6, wherein the correction step consists of applying a linear correction to the height values reached by the sports practitioner.

9. Method according to claim 6, wherein the correction step consists of applying a linear combination of a quadratic correction and a linear correction to the height values reached by the sports practitioner, the coefficients of the linear combination being determined by a statistical analysis of several jumps.

10. Method according to claim 6, wherein the correction step is applied to a sub-sampling of the set of height values reached by the sports practitioner during the jump.

11. Method according to claim 1, wherein, when the connected sensor also comprises a satellite positioning module, the method comprises:
a step of determining a second height of the jump based on the satellite positioning; and
a step of combining the determined height of the jump and the second height of the jump as a function of the confidence level of each of these values in order to determine the final estimation of the height of the jump.

12. Statistical calculation system for determining and displaying the height of a jump performed by a sports practitioner practising a water-based board sport, the system comprising:
a connected sensor, said connected sensor comprising at least one measurement sensor including an accelerometer;
means of determining the ascending velocity of the sports practitioner based on data originating from the accelerometer;
means of detecting a jump by recognizing the different phases of the jump by analyzing the acceleration and the velocity of the sports practitioner;
means of determining the height values reached by the sports practitioner between the start and the end of the jump by integrating the ascending velocity;
means of determining the height of the jump as being the maximum value from the height values;
means of displaying the height of the jump.

13. Connected sensor for determining the height of a jump performed by a sports practitioner practising a water-based board sport, the connected sensor comprising:
at least one measurement sensor including an accelerometer;
means of determining the ascending velocity of the sports practitioner based on data originating from the accelerometer;
means of detecting a jump by recognizing the different phases of the jump by analyzing the acceleration and the velocity of the sports practitioner;
means of determining the height values reached by the sports practitioner between the start and the end of the jump by integration of the ascending velocity;
means of determining the height of the jump as being the maximum value from the height values;
means of transmitting the height of the jump.

14. (canceled)

15. A non-transitory medium readable by a computer or a microprocessor comprising code instructions of a computer program for executing each of the steps of the method according to claim 1.

16. Method according to claim 2, wherein the step of detecting a jump comprises in order:
detecting the start of the jump when the ascending velocity exceeds a predetermined threshold;
detecting the start of the descent when the ascending velocity becomes negative;
detecting the start of the water landing when the ascending acceleration exceeds a predetermined threshold;
detecting the end of the water landing, and thus the end of the jump, when the ascending acceleration becomes less than a predetermined threshold.

17. Method according to claim 3, wherein the step of detecting a jump comprises in order:
detecting the start of the jump when the ascending velocity exceeds a predetermined threshold;
detecting the start of the descent when the ascending velocity becomes negative;
detecting the start of the water landing when the ascending acceleration exceeds a predetermined threshold;
detecting the end of the water landing, and thus the end of the jump, when the ascending acceleration becomes less than a predetermined threshold.

18. Method according to claim 2, further comprising:
a step of correcting the height values reached by the sports practitioner during the jump in order to ensure that the final measured height is zero.

19. Method according to claim 3, further comprising:
a step of correcting the height values reached by the sports practitioner during the jump in order to ensure that the final measured height is zero.

20. Method according to claim 4, further comprising:
a step of correcting the height values reached by the sports practitioner during the jump in order to ensure that the final measured height is zero.

21. Method according to claim 5, further comprising:
a step of correcting the height values reached by the sports practitioner during the jump in order to ensure that the final measured height is zero.
